(19) United States
(12) Patent Application Publication
(10) Pub. No.: US 2026/0106262 A1
(43) Pub. Date: Apr. 16, 2026

(54) COOLING BEAM FOR A BATTERY PACK

(71) Applicant: GM Global Technology Operations LLC, Detroit, MI (US)

(72) Inventors: Lu Huang, Troy, MI (US); Hui-ping Wang, Troy, MI (US); Alexander M. Bilinski, Avoca, MI (US); Phillip Daniel Hamelin, Holly, MI (US); William Yu Chen, Troy, MI (US); Yunzhi Xu, Ferndale, MI (US)

(73) Assignee: GM Global Technology Operations LLC, Detroit, MI (US)

(21) Appl. No.: 18/916,034

(22) Filed: Oct. 15, 2024

(51) Int. Cl. H01M 10/6557; B60L 50/64; H01M 10/613; H01M 10/625; H01M 10/647

(52) U.S. Cl. CPC H01M 10/6557; B60L 50/64; H01M 10/613; H01M 10/625; H01M 10/647; H01M 2220/20

(57) ABSTRACT

A cooling beam having a first end and a second end spaced from the first end, comprising one or more outer plates extending between the first end and the second end, the one or more outer plates each having an upper end and a lower end that each extend between the first end and the second end of the cooling beam, and the one or more outer plates each having an inner surface and an outer surface spaced from the inner surface, one or more cooling channels extending between the first end and the second end and coupled to the inner surface of the one or more outer plates, and a coolant pathway arranged between the inner surface of the one or more outer plates and the one or more cooling channels, the coolant pathway configured to carry a fluid between one or more inlets and one or more outlets.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery packs for electric vehicles and, more particularly, to cooling beams arranged between one or more battery cells.

Some rechargeable energy storage systems (RESS) can include one or more battery cells and one or more cooling channels arranged between or below the one or more battery cells. Existing RESS can occupy a large footprint and add a considerable amount of weight to a vehicle. Additionally, assembly and packaging these systems can be complex due to the number of components and the large footprint required to package the system in the vehicle. Shortcomings of existing systems are addressed by one or more aspects of the present disclosure.

### SUMMARY

In one configuration, a cooling beam having a first end and a second end spaced from the first end is provided and includes one or more outer plates extending between the first end and the second end, the one or more outer plates each having an upper end and a lower end that each extend between the first end and the second end of the cooling beam, and the one or more outer plates each having an inner surface and an outer surface spaced from the inner surface. One or more cooling channels extend between the first end and the second end and are coupled to the inner surface of the one or more outer plates, and a coolant pathway is arranged between the inner surface of the one or more outer plates and the one or more cooling channels, the coolant pathway configured to carry a fluid between one or more inlets and one or more outlets.

The cooling beam may include one or more of the following optional aspects. For example, the one or more outer plates can include a first outer plate and second outer plate. The inner surface of the first outer plate and the inner surface of the second outer plate can face each other and define a chamber that is configured to carry a fluid. The one or more cooling channels can include a first cooling channel that is coupled to the inner surface of the first outer plate and a second cooling channel that is coupled to the inner surface of the second outer plate. The first cooling channel can include an inner surface that has one or more concave portions that face the inner surface of the first outer plate and an outer surface that has one or more convex portions that correspond with the concave portions. The second cooling channel can include an inner surface that has one or more concave portions that face the inner surface of the second outer plate and an outer surface that has one or more convex portions that correspond with the concave portions.

According to one aspect, the first cooling channel and the second cooling channel can be arranged in the chamber so that the convex portions of the first cooling channel align with and contact the convex portions of the second cooling channel.

According to another aspect, the first cooling channel and the second cooling channel can be arranged in the chamber so that the convex portions of the first cooling channel are offset from the convex portions of the second cooling channel.

According to at least one example, the one or more outer plates can include a thickness between 0.1 millimeters (mm) and 0.5 mm. The one or more cooling channels can include a thickness between 0.1 millimeters (mm) and 0.5 mm.

In another configuration, a battery pack is provided and includes one or more battery cells, the one or more battery cells each including a prismatic can, including a first end and a second end spaced from the first end, a third end and a fourth end spaced from the third end, a first surface extending between the first, second, third, and fourth ends, and a second surface extending between the first, second, third, and fourth ends, and spaced from the first surface. The battery pack further including one or more cooling beams having a first end and a second end, including one or more outer plates extending between the first end and the second end, the one or more outer plates each having an upper end and a lower end that each extend between the first end and the second end of the cooling beam, and the one or more outer plates each having an inner surface and an outer surface spaced from the inner surface. The outer surfaces are configured to contact the first surface or the second surface of the one or more battery cells. One or more cooling channels extend between the first end and the second end and are coupled to the inner surface of the one or more outer plates. A coolant pathway is arranged between the inner surface of the one or more outer plates and the one or more cooling channels.

The battery pack may include one or more of the following optional aspects. For example, the one or more outer plates can include a first outer plate and a second outer plate coupled to the first outer plate. The first outer plate and the second outer plate can each include a first flange at the upper ends of the first outer plate and the second outer plate, the first flange of the first outer plate extends generally perpendicular from the outer surface of the first outer plate, and the first flange of the second outer plate depends toward the lower ends of the first outer plate and the second outer plate. The first outer plate and the second outer plate each include a second flange at the lower ends of the first outer plate and the second outer plate, the second flange of the first outer plate depends toward the upper ends of the first outer plate and the second outer plate, and the second flange of the second outer plate extends generally perpendicular from the outer surface of the second outer plate. The first flange of the first outer plate can be configured to contact the third end of one prismatic can and the second flange of the second outer plate can be configured to contact the fourth end of another prismatic can.

In another configuration, a vehicle is provided and includes a vehicle body, a motor coupled to the vehicle body, and a battery pack coupled to the vehicle body and communicatively coupled to the motor. The battery pack includes one or more battery cells each having a prismatic can and one or more cooling beams each having a first end and a second end spaced from the first end, the one or more cooling beams being arranged between the one or more battery cells. The one or more cooling beams include one or more outer plates extending between the first end and the second end, the one or more outer plates each having an upper end and a lower end that each extend between the first end and the second end of the cooling beam, and the one or more outer plates each have an inner surface and an outer surface spaced from the inner surface, the outer surfaces being configured to contact the prismatic can of the one or more battery cells. One or more cooling channels extend between the first end and the second end and are coupled to the inner surface of the one or more outer plates. A coolant pathway is arranged between the inner surface of the one or more outer plates and the one or more cooling channels.

The battery pack may include one or more of the following optional aspects. For example, the one or more outer plates can include a first outer plate and a second outer plate coupled to the first outer plate. The first outer plate and the second outer plate can each include a first flange at the upper ends of the first outer plate and the second outer plate, the first flange of the first outer plate extends generally perpendicular from the outer surface of the first outer plate, and the first flange of the second outer plate depends toward the lower ends of the first outer plate and the second outer plate. The first outer plate and the second outer plate can each include a second flange at the lower ends of the first outer plate and the second outer plate, the second flange of the first outer plate depends toward the upper ends of the first outer plate and the second outer plate, and the second flange of the second outer plate extends generally perpendicular from the outer surface of the second outer plate.

According to at least one aspect, the one or more outer plates and the one or more cooling channels each include a thickness between 0.1 millimeters (mm) and 0.5 mm.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a battery pack according to principles of the present disclosure;

FIG. 2 is a side perspective view of a portion of the battery pack of FIG. 1 including one or more battery cells and one or more cooling beams;

FIG. 3 is a side perspective view of one of the one or more cooling beams of FIG. 2;

FIG. 4 is an exploded view of the cooling beam of FIG. 3;

FIG. 5 is a cross-sectional view of one configuration of the battery pack of FIG. 2 according to the principles of the present disclosure; and FIG. 6 is a cross-sectional view of another configuration of the battery pack of FIG. 2 according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

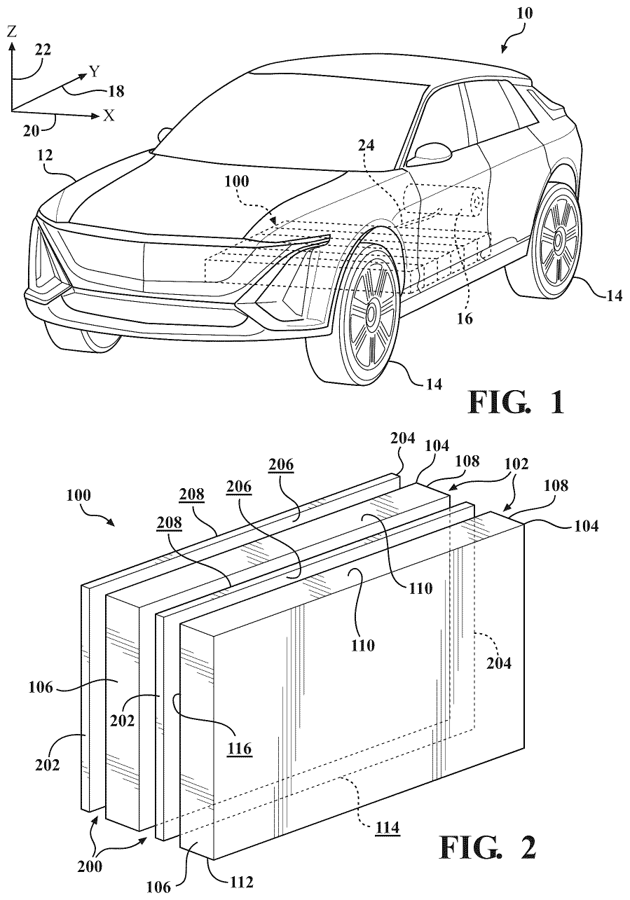

With reference to FIG. 1, a vehicle 10, such as an electric motor vehicle, is provided. The vehicle 10 includes a vehicle body 12, one or more wheels 14, and an electric motor 16 arranged in the vehicle body 12. The vehicle body 12 extends in a first direction (i.e., a fore-aft or longitudinal direction) 18, a second direction (i.e., a cross-car or lateral direction) 20, and a third direction (i.e., a vertical direction) 22. The electric motor 16 may be configured to drive one or more of the one or more wheels 14 to propel the vehicle 10. The vehicle 10 includes a battery pack 100 that can be arranged in the vehicle body 12 and is communicatively coupled to the electric motor 16 via an electric power cable 24.

With reference to FIG. 2, a portion of the battery pack 100 is provided and generally includes one or more battery cells 102 and one or more cooling beams 200 arranged between the one or more battery cells 102. For illustrative purposes, the one or more battery cells 102 and the one or more cooling beams 200 are shown spaced from each other. However, in assembly, the one or more battery cells 102 and the one or more cooling beams 200 can be arranged such that the one or more cooling beams 200 can remove heat from the one or more cells during operation and during charging, for example.

With continued reference to FIG. 2, the one or more battery cells 102 can each include a prismatic can 104 that has a first end 106, a second end 108 spaced from the first end 106, a third or upper end 110, and a fourth or lower end 112 spaced from the upper end 110. Additionally, each prismatic can 104 include a first surface 114 and a second surface 116 spaced from the first surface 114. The first surface 114 and the second surface 116 each extend between the first end 106, the second end 108, the upper end 110, and the lower end 112. According to one aspect, the first surface 114 and the second surface 116 can be the largest surfaces of the prismatic can 104 and can be configured to transmit heat away from the prismatic can 104.

With continued reference to FIG. 2, the one or more cooling beams 200 include a first end 202 and a second end 204 spaced from the first end 202. Additionally, each of the one or more cooling beams 200 includes a first cooling surface 206 and a second cooling surface 208 spaced from the first cooling surface 206 that are configured to engage with and/or contact the prismatic can 104.

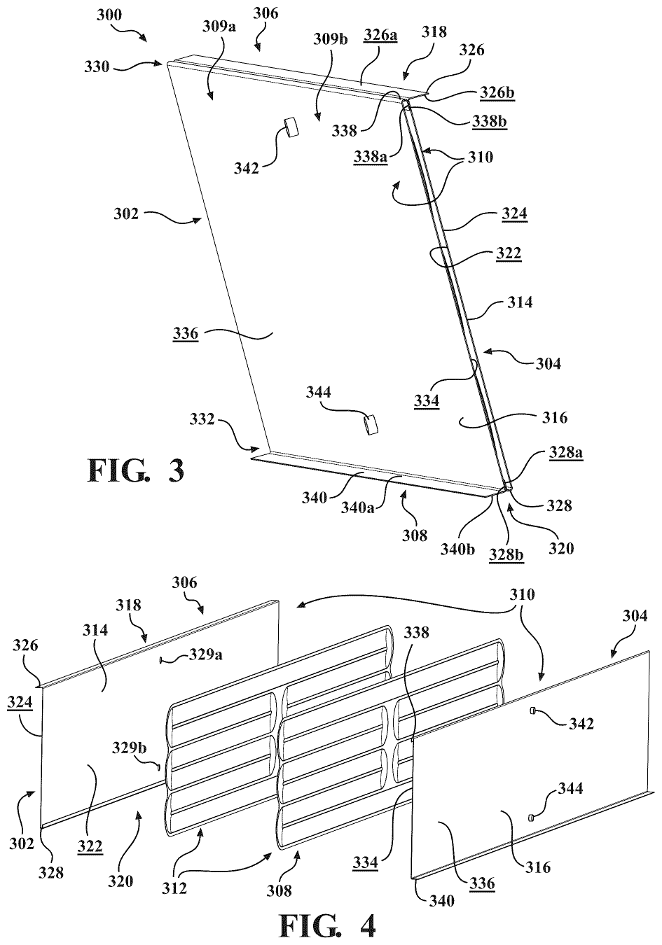

FIGS. 3-5 provide an illustrative configuration of a cooling beam 300. This configuration is similar in many respects to the configuration of FIGS. 1 and 2. Accordingly, the descriptions of the configurations are hereby incorporated into one another, and description of subject matter common to the configurations generally may not be repeated.

With reference to FIG. 3, the cooling beam 300 includes a first end 302, a second end 304 spaced from the first end 302, a third or upper end 306, and a fourth or lower end 308 spaced from the upper end 306. The cooling beam 300 can also include a first region 309a near the first end 302 and a second region 309b near the second end 304. In one configuration, one or more of the battery cells 102 can be arranged adjacent to or with respect to the first region 309a and one or more of the battery cells 102 can be arranged adjacent to or with respect to the second region 309b. The cooling beam 300 can include one or more outer plates 310 and one or more cooling channels (e.g., cooling sheets) 312 coupled to and arranged between the one or more outer plates 310.

In the present illustrative configuration, with reference to FIGS. 3 and 4, the one or more outer plates 310 include a first outer plate 314 and a second outer plate 316. The first outer plate 314 includes a first end 318 and a second end 320 spaced from the first end 318. The first outer plate 314 also includes a first or inner surface 322 and a second or outer surface 324 opposite the inner surface 322. The inner and outer surfaces 322, 324 can both extend between the first and second ends 318, 320. At the first end 318, a first flange 326 can be coupled to and extend away from the first end 318 and/or from the outer surface 324. The first flange 326 can extend between the first end 302 and the second end 304 of the cooling beam 300 and the first flange 326 can be generally perpendicular to the outer surface 324. Additionally, the first flange 326 can include a first or top surface 326a and a second or bottom surface 326b opposite the top surface 326a. At the second end 320, a second flange 328 can be coupled to and extend away (i.e., depend away from) the second end 320 and/or from the inner surface 322 toward the first end 318 of the first outer plate 314. The second flange 328 can extend between the first end 302 and the second end 304 of the cooling beam 300. Additionally, the second flange 328 includes a first or inner surface 328a that faces the inner surface 322 of the first outer plate 314 and a second or outer surface 328b that is opposite the inner surface 328a and faces away from the inner surface 322. The first outer plate 314 also includes one or more inlets 329a and one or more outlets 329b that are configured to receive a fluid, such as a coolant.

With continued reference to FIGS. 3 and 4, the second outer plate 316 includes a first end 330 and a second end 332 spaced from the first end 330. The second outer plate 316 also includes a first or inner surface 334 and a second or outer surface 336 opposite the inner surface 334. The inner and outer surfaces 334, 336 can both extend between the first and second ends 330, 332. At the first end 330, a first flange 338 can be coupled to and extend away (i.e., depend away) from the first end 330 and/or from the inner surface 334 toward the second end 332 of the second outer plate 316. The first flange 338 can extend between the first end 302 and the second end 304 of the cooling beam 300. Additionally, the first flange 338 includes a first or inner surface 338a that faces the inner surface 334 of the second outer plate 316 and a second or outer surface 338b that is opposite the inner surface 338a and faces away from the inner surface 334. At the second end 332, a second flange 340 can be coupled to and extend away from the second end 332 and/or from the outer surface 336. The second flange 340 can extend between the first end 330 and the second end 332 of the cooling beam 300 and the second flange 340 can be generally perpendicular to the outer surface 336. Additionally, the second flange 340 can include a first or top surface 340a and a second or bottom surface 340b opposite the top surface 340a. The second outer plate 316 also includes one or more inlets 342 and one or more outlets 344 that are configured to receive a fluid, such as a coolant.

According to one aspect, the first outer plate 314 and the second outer plate 316 can be made of aluminum alloys or steels with thicknesses ranging from 0.1 millimeters (mm) to 0.5 mm. Selecting such materials is desirable to reduce mass and cost of each of the one or more cooling beams 300.

In assembly, the first outer plate 314 can be coupled to or otherwise attached to the second outer plate 316 to define a fluid-tight chamber or cavity 345 between the inner surface 322 of the first outer plate 314 and the inner surface 334 of the second outer plate 316. The first end 318 of the first outer plate 314 and the first end 330 of the second outer plate 316 can be arranged at the upper end 306 of the cooling beam 300. In other words, the inner surface 322 of the first outer plate 314 can contact and be coupled with the outer surface 338b of the first flange 338 of the second outer plate 316. The second end 320 of the first outer plate 314 and the second end 332 of the second outer plate 316 can be arranged at the lower end 308 of the cooling beam 300. More particularly, the inner surface 334 of the second outer plate 316 can contact and be coupled with the outer surface 328b of the second flange 328 of the first outer plate 314. According to one aspect, the first flange 326 of the first outer plate 314 and the second flange 340 of the second outer plate 316 can be coupled or otherwise attached to a battery tray (not shown). The battery tray can be configured to protect the one or more battery cells 102 and the one or more cooling beams 300 from wear or damage due to air, water, etc.

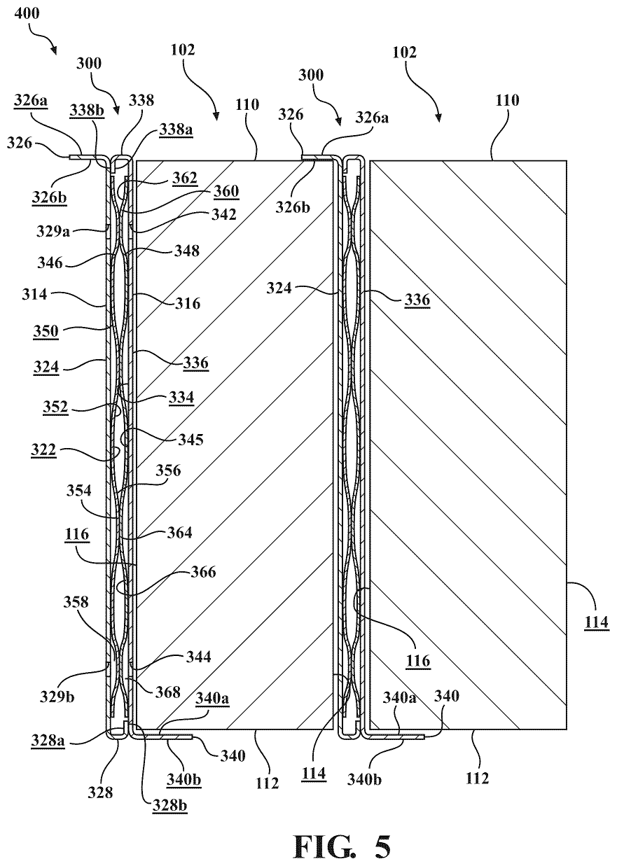

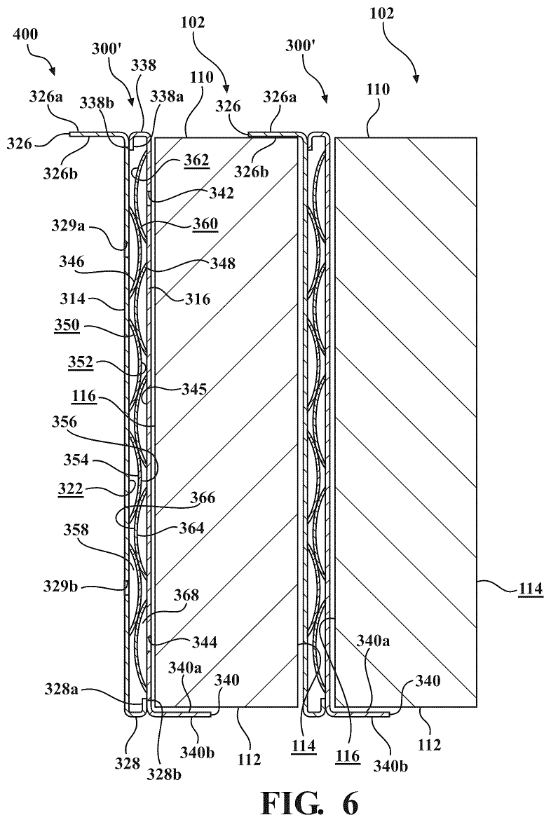

With reference to FIG. 5, the one or more cooling channels 312 can include a first cooling channel 346 and a second cooling channel 348. The first cooling channel 346 extends between the first end 302 and the second end 304 of the one or more cooling beams 300. Additionally, the first cooling channel 346 includes an inner surface 350 and an outer surface 352 opposite the inner surface 350. The inner surface 350 includes one or more concave portions 354 and the outer surface 352 includes one or more convex portions 356 that correspond with the concave portions 354. A portion of the inner surface 350 of the first cooling channel 346 can be configured to be coupled to or otherwise attached to the inner surface 322 of the first outer plate 314. A first cooling pathway 358 can be arranged between the inner surface 322 of the first outer plate 314 and the inner surface 350 of the first cooling channel 346. The first cooling pathway 358 can include a serpentine pathway between the first end 302 and the second end 304 of the one or more cooling beams 300, as shown in FIG. 4. Also, the first cooling pathway 358 can be communicatively coupled with the one or more inlets 329a and the one or more outlets 329b such that fluid can flow along the first cooling pathway 358 between the one or more inlets 329a and the one or more outlets 329b.

The second cooling channel 348 extends between the first end 302 and the second end 304 of the one or more cooling beams 300. Additionally, the second cooling channel 348 includes an inner surface 360 and an outer surface 362 opposite the inner surface 360. The inner surface 360 includes one or more concave portions 364 and the outer surface 362 includes one or more convex portions 366 that correspond with the concave portions 364. A portion of the inner surface 360 of the second cooling channel 348 can be configured to be coupled to or otherwise attached to the inner surface 334 of the second outer plate 316. A second cooling pathway 368 can be arranged between the inner surface 334 of the second outer plate 316 and the inner surface 360 of the second cooling channel 348. The second cooling pathway 368 can include a serpentine pathway between the first end 302 and the second end 304 of the one or more cooling beams 300, as shown in FIG. 4. Also, the second cooling pathway 368 can be communicatively coupled with the one or more inlets 342 and the one or more outlets 344 such that fluid can flow along the second cooling pathway 368 between the one or more inlets 342 and the one or more outlets 344.

According to one aspect, the first cooling channel 346 and the second cooling channel 348 can be made of aluminum alloys or steels with thicknesses ranging from 0.1 millimeters (mm) to 0.5 mm. Selecting such materials is desirable to reduce mass and cost of each of the one or more cooling beams 300.

In the present illustrative configuration, the first cooling channel 346 and the second cooling channel 348 can be arranged such that the convex portions 356 of the first cooling channel 346 align with and contact the convex portions 366 of the second cooling channel 348, as shown in FIG. 5. In another configuration of the cooling beam 300′, the first cooling channel 346 and the second cooling channel 348 can be staggered with respect to one another. In other words, the first cooling channel 346 can be arranged with respect to the second cooling channel 348 such that the convex portions 356 of the first cooling channel 346 are offset from the convex portions 366 of the second cooling channel 348, as shown in FIG. 6.

With reference to FIGS. 5 and 6, a battery pack 400 can be arranged such that the outer surface 324 of the first outer plate 314 contacts the first surface of one prismatic can 104 and the outer surface 336 of the second outer plate 316 contacts the second surface 116 of another prismatic can 104. In other words, the one or more cooling beams 300 can be sandwiched between two or more prismatic cans 104. Additionally, the bottom surface 326b of the first flange 326 of the first outer plate 314 can contact the upper end 110 of one prismatic can 104 and the top surface 340a of the second flange 340 of the second outer plate 316 can contact the lower end 112 of another prismatic can 104.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A cooling beam having a first end and a second end spaced from the first end, comprising:
one or more outer plates extending between the first end and the second end, the one or more outer plates each having an upper end and a lower end that each extend between the first end and the second end of the cooling beam, and the one or more outer plates each having an inner surface and an outer surface spaced from the inner surface;
one or more cooling channels extending between the first end and the second end and coupled to the inner surface of the one or more outer plates; and
a coolant pathway arranged between the inner surface of the one or more outer plates and the one or more cooling channels, the coolant pathway configured to carry a fluid between one or more inlets and one or more outlets.

2. The cooling beam of claim 1, wherein the one or more outer plates includes a first outer plate and a second outer plate.

3. The cooling beam of claim 2, wherein the inner surface of the first outer plate and the inner surface of the second outer plate face each other and define a chamber that is configured to carry a fluid.

4. The cooling beam of claim 3, wherein the one or more cooling channels includes a first cooling channel that is coupled to the inner surface of the first outer plate and a second cooling channel that is coupled to the inner surface of the second outer plate.

5. The cooling beam of claim 4, wherein the first cooling channel includes an inner surface that has one or more concave portions that face the inner surface of the first outer plate and an outer surface that has one or more convex portions that correspond with the concave portions.

6. The cooling beam of claim 5, wherein the second cooling channel includes an inner surface that has one or more concave portions that face the inner surface of the second outer plate and an outer surface that has one or more convex portions that correspond with the concave portions.

7. The cooling beam of claim 6, wherein the first cooling channel and the second cooling channel are arranged in the chamber so that the convex portions of the first cooling channel align with and contact the convex portions of the second cooling channel.

8. The cooling beam of claim 6, wherein the first cooling channel and the second cooling channel are arranged in the chamber so that the convex portions of the first cooling channel are offset from the convex portions of the second cooling channel.

9. The cooling beam of claim 1, wherein the one or more outer plates include a thickness between 0.1 millimeters (mm) and 0.5 mm.

10. The cooling beam of claim 9, wherein the one or more cooling channels include a thickness between 0.1 mm and 0.5 mm.

11. A battery pack, comprising:
one or more battery cells, the one or more battery cells each comprising:
a prismatic can, comprising:
a first end and a second end spaced from the first end,
a third end and a fourth end spaced from the third end,
a first surface extending between the first, second, third, and fourth ends, and
a second surface extending between the first, second, third, and fourth ends, and spaced from the first surface; and
one or more cooling beams having a first end and a second end, comprising:
one or more outer plates extending between the first end and the second end, the one or more outer plates each having an upper end and a lower end that each extend between the first end and the second end of the cooling beam, and the one or more outer plates each having an inner surface and an outer surface spaced from the inner surface, the outer surfaces being configured to contact the first surface or the second surface of the one or more battery cells,
one or more cooling channels extending between the first end and the second end and coupled to the inner surface of the one or more outer plates, and
a coolant pathway arranged between the inner surface of the one or more outer plates and the one or more cooling channels.

12. The battery pack of claim 11, wherein the one or more outer plates includes a first outer plate and a second outer plate coupled to the first outer plate.

13. The battery pack of claim 12, wherein the first outer plate and the second outer plate each include a first flange at the upper ends of the first outer plate and the second outer plate, the first flange of the first outer plate extends generally perpendicular from the outer surface of the first outer plate, and the first flange of the second outer plate depends toward the lower ends of the first outer plate and the second outer plate.

14. The battery pack of claim 13, wherein the first outer plate and the second outer plate each include a second flange at the lower ends of the first outer plate and the second outer plate, the second flange of the first outer plate depends toward the upper ends of the first outer plate and the second outer plate, and the second flange of the second outer plate extends generally perpendicular from the outer surface of the second outer plate.

15. The battery pack of claim 14, wherein the first flange of the first outer plate is configured to contact the third end of one prismatic can and the second flange of the second outer plate is configured to contact the fourth end of another prismatic can.

16. A vehicle, comprising:
a vehicle body;
a motor coupled to the vehicle body; and
a battery pack coupled to the vehicle body and communicatively coupled to the motor, the battery pack comprising:
one or more battery cells each having a prismatic can, and
one or more cooling beams each having a first end and a second end spaced from the first end, the one or more cooling beams being arranged between the one or more battery cells, the one or more cooling beams comprising:
one or more outer plates extending between the first end and the second end, the one or more outer plates each having an upper end and a lower end that each extend between the first end and the second end of the cooling beam, and the one or more outer plates each having an inner surface and an outer surface spaced from the inner surface, the outer surfaces being configured to contact the prismatic can of the one or more battery cells,
one or more cooling channels extending between the first end and the second end and coupled to the inner surface of the one or more outer plates, and
a coolant pathway arranged between the inner surface of the one or more outer plates and the one or more cooling channels.

17. The vehicle of claim 16, wherein the one or more outer plates includes a first outer plate and a second outer plate coupled to the first outer plate.

18. The vehicle of claim 17, wherein the first outer plate and the second outer plate each include a first flange at the upper ends of the first outer plate and the second outer plate, the first flange of the first outer plate extends generally perpendicular from the outer surface of the first outer plate, and the first flange of the second outer plate depends toward the lower ends of the first outer plate and the second outer plate.

19. The vehicle of claim 18, wherein the first outer plate and the second outer plate each include a second flange at the lower ends of the first outer plate and the second outer plate, the second flange of the first outer plate depends toward the upper ends of the first outer plate and the second outer plate, and the second flange of the second outer plate extends generally perpendicular from the outer surface of the second outer plate.

20. The battery pack of claim 16, wherein the one or more outer plates and the one or more cooling channels each include a thickness between 0.1 millimeters (mm) and 0.5 mm.
